(19) United States
(12) Patent Application Publication
(10) Pub. No.: US 2008/0275273 A1
(43) Pub. Date: Nov. 6, 2008

(54) Method for Synthesizing Long-Chain Phosphonic Acid Derivatives and Thiol Derivatives

(75) Inventors: Franz Effenberger, Stuttgart (DE); Steffen Maisch, Gerlingen (DE); Steffen Seifritz, Ditzingen (DE); Guenter Schmid, Hemhofen (DE); Marcus Halik, Erlangen (DE); Hagen Klauk, Stuttgart (DE); Ute Zschieschang, Stuttgart (DE)

Correspondence Address: DICKE, BILLIG & CZAJA, FIFTH STREET TOWERS, 100 SOUTH FIFTH STREET, SUITE 2250, MINNEAPOLIS, MN, 55402, US

(73) Assignee: QIMONDA AG, Muenchen (DE)

(21) Appl. No.: 11/720,453

(22) PCT Filed: Nov. 23, 2005
(86) PCT No.: PCT/EP05/56176

§ 371 Date: Mar. 6, 2008

(30) Foreign Application Priority Data
Nov. 30, 2004 (DE) 10 2004 057 760

(51) Int. Cl. C07F 9/40

(52) U.S. Cl. 568/14

(57) ABSTRACT

A process for synthesizing long-chain phosphonic acid derivatives and thiol derivative is disclosed. One embodiment provides organic compounds which can form a self-assembled monolayer and are obtained by reaction of an olefin with a thiocarboxylic acid and subsequent hydrogenation to give the thiol, or with a phosphite and subsequent hydrolysis to give the phosphonic acid.

### BACKGROUND

The present invention relates to two novel processes for preparing low molecular weight organic compounds, which can be used for the production of thin dielectric layers in the field of microelectronics, especially the field of polymer electronics, in electronic components, such as in organic field-effect transistors (OFETs). The organic compounds may be applied to a suitable substrate in the form of a self-assembled monolayer (SAM).

Until a few years ago, microelectronics was based exclusively on the use of inorganic semiconductors, such as silicon or gallium arsenide. These inorganic materials necessitate complicated and costly processes for producing the structured electronic components having them. This had the consequence, among others, that microelectronics was restricted essentially to the production of high-value products. In the last few years, a multitude of new electronic applications has been proposed, which are intended firstly to utilize the technical achievements in silicon-based microelectronics, but secondly are intended for mass production. Products which have been manufactured in polymer electronics technology have to satisfy requirements, for example manufacturing costs, which are not achievable even in ultrahigh-volume silicon technology, the use of flexible or unbreakable substrates or the production of transistors and integrated circuits over large active areas.

Examples of such mass products are large-area active matrix visual display units, which are expected to increasingly replace the established tube units, or else RFID systems (abbreviation for “radio frequency identification”), which are used for the active labeling and identification of wares and goods.

Active matrix visual display units, such as TFT-LC displays, typically include field-effect transistors based on amorphous or polycrystalline silicon layers. For the production of these high-value transistors, temperatures are needed which are commonly above 250° C. Such high temperatures necessitate the use of rigid and breakable glass or quartz substrates.

Transponders, as used in RFID technology, are commonly produced using integrated circuits based on monocrystalline silicon. This leads, inter alia, to considerable costs in the structuring and bonding technology. Passive RF-ID systems draw their energy from the incident alternating field. The maximum permissible distance between the reading instrument and the transponder for the reading operation depends on the emitted power of the reading instrument and the energy requirement of the transponder. Silicon-based transponders therefore work at supply voltages around 3 V. Products which include a silicon-based chip are too expensive for many applications. Therefore, for example, silicon-based ident tags are not an option for the labeling of foods, for example for stating the price and the use-by date, for reasons of cost.

The problems described above have led to the development of microelectronic components which include low molecular weight organic materials or organic polymers in place of inorganic materials, such as the abovementioned amorphous, polycrystalline or monocrystalline silicon. This new field is also referred to as polymer electronics.

Examples of microelectronic components based on organic components are organic field-effect transistors (abbreviation: “OFETs”) in, for example, “bottom-gate bottom-contact” architecture. For the production of these thin-film transistors, the gate electrode is deposited on a substrate in the first step, after which the gate dielectric (i.e. the insulator layer) is applied. In the next step, this is followed by the deposition and the structuring of the source electrode and of the drain electrode. In the last step, the semiconductor is deposited on the gate dielectric between the source electrode and the drain electrode. Optionally, as a last layer, this is also followed by the deposition of a passivation layer. Such a transistor is referred to as an OFET when at least the active semiconductor layer consists of an organic semiconductor. What is desired is the production of OFETs in which further layers, such as the substrate and/or the gate dielectric, consist of organic materials with tailored properties. The basic structure of an OFET or polymer transistor with “bottom-gate” structure is illustrated in FIG. 1.

OFETs may be used for the production of transistors and integrated circuits over large active areas, for example as pixel control elements in the active matrix visual display units mentioned above. Moreover, they open up a route to extremely inexpensive integrated circuits, as required for transponders in RFID systems.

One advantage of organic microelectronic components, such as OFETs, is the fact that organic materials which can be processed at relatively low temperatures commonly below 200° C. are used. It is therefore possible to use cheap, flexible, transparent and unbreakable polymer films instead of rigid and breakable glass or quartz substrates.

The organic materials also enable the use of rapid, simple and inexpensive production techniques. For example, cheap printing techniques can be used in order to apply the polymers used for the different layers and/or low molecular weight organic materials to the flexible substrate and to structure them.

The thinner the gate dielectric is produced, the smaller the gate potential which can be selected for the control of transistors. Qualitatively high-value, extremely thin dielectric layers of organic materials are therefore of exceptional interest for a multitude of applications, such as the realization of the abovementioned inexpensive substrates, some of them battery-driven and some of them on large-area flexible substrates.

In polymer electronics, the thickness of the gate dielectric is generally optimized by applying the solution of the polymer by spin-coating or printing ever more thinly (top-down). However, this procedure meets its limits when layer thicknesses below 50 nm are to be achieved. The generation of organic gate dielectrics with a thickness below 50 nm is enabled by the use of long-chain organic molecules which consist of an anchor group, a dielectric unit and an optional head group. In the event of correct adjustment of the chemical composition and structure of the anchor group to the chemical properties of the surface on which the organic dielectric is to be formed, there is self-assembly of the long-chain organic molecules on the surface on which the molecules are to be anchored on the surface via their anchor group. The layers thus obtainable consist of monolayers of the long-chain organic compound and are accordingly referred to as self-assembled monolayers (abbreviation: SAM). SAMs have outstanding insulating properties and can be used as a gate dielectric in the transistor architecture outlined in FIG. 1. They have a thickness of less than 5 nm to especially between 1.5 nm and 3 nm. This process can be referred to as a bottom-up approach.

Since the thickness of the organic dielectric directly determines the required supply voltage, great efforts are taken to simplify the process for producing SAMs and for achieving minimum layer thicknesses of the SAMs.

German patent applications DE 103 28 810 and DE 103 28 811 describe the preparation of molecules with silane-based anchor groups, which form T-SAMs (“top-linked self-assembled monolayers”). T-SAMs are used as an insulator layer in OFETs. As well as the anchor group and the dielectric unit, molecules for T-SAMs additionally have a head group. The head groups of these molecules ensure particular stability of the SAMs toward chemical and physical attacks by various processes, such as wet-chemical etching or metal deposition, by stabilizing the layer additionally by forming a binding π-π interaction (top-link). In the case of the silane-based anchor groups, the top-link has enabled first the production of gate dielectrics of appropriate quality and hence the production of OFETs.

The molecules with a silane anchor group described in these two patent applications are particularly suitable for the formation of monolayers on silicon substrates with a natural silicon oxide layer. The compounds with a silane anchor group described in DE 103 28 810 and DE 103 28 811 likewise form SAMs on gate electrodes composed of base metals, such as aluminum and titanium, whose surface is always oxidic. However, the leakage currents of the gate dielectrics are too high for real applications which are obtained with these SAMs, for example by depositing 18-phenoxyoctadecyl-1-trichlorosilane, on aluminum.

German patent application 10 2004 009 600.7 describes organic molecules with a phosphonic acid anchor group, which can serve to form SAMs in OFETs. They are particularly suitable for aluminum substrates. This compound class is, though, obtainable only with very great difficulty. Only phosphonic acids with a terminal methyl group are commercially available, i.e. these commercial products lack the head group which is capable of π-π interactions and is arranged in the ω-position to the phosphonic acid radical, which brings about the top-link between the long-chain molecules of the SAM and hence ensures the stability of the SAM.

Phosphonic acids with a long alkyl chain and a terminal methyl group can be prepared by nucleophilic substitution (S_{N}2 mechanism) of a long-chain alkyl bromide with a trialkyl phosphite in a Michaelis-Arbuzov reaction. For example, the reaction of 1-octadecyl bromide with triethyl phosphite forms the commercially available octadecylphosphonic acid in a good yield.

For the corresponding alkyl bromides which are substituted additionally in the ω-position with a head group capable of top-linking (for example the phenoxy group), this is, however, not the case. The long-chain alkylphosphonic acids ω-substituted by a head group are obtained by the Michaelis-Arbuzov reaction only in very low yields. Moreover, the reaction mixture formed in this reaction can be separated into its constituents only with very great difficulty.

In polymer electronics, gold is often used as an electrode material. According to the integration scheme, gold can also be used to form the gate layer. It is known that, for the production of SAMs on electrodes composed of gold or other noble metals, long-chain organic compounds with a thiol as anchor groups are particularly suitable. As is the case for the above-specified long-chain phosphonic acids and their derivatives, it is particularly advantageous in the case of the long-chain thiols and derivatives thereof too when they are provided with a head group capable of top-linking (i.e. of π-π interaction). Processes for preparing long-chain thiols and thiol derivatives with an ω-position head group capable of π,π interaction are to date unknown.

### BRIEF DESCRIPTION OF THE DRAWINGS

The accompanying drawings are included to provide a further understanding of the present invention and are incorporated in and constitute a part of this specification. The drawings illustrate the embodiments of the present invention and together with the description serve to explain the principles of the invention. Other embodiments of the present invention and many of the intended advantages of the present invention will be readily appreciated as they become better understood by reference to the following detailed description. The elements of the drawings are not necessarily to scale relative to each other. Like reference numerals designate corresponding similar parts.

FIG. 1 illustrates the basic structure of a polymer transistor with a bottom-gate bottom-contact structure.

FIG. 2 illustrates a bottom-gate top-contact structure, with which the suitability of the organic materials obtained in the working examples which follow for microelectronics is examined, the gate electrode consisting of aluminum or gold.

FIG. 3 reproduces the characteristics of the test transistor whose gate dielectric consists of a self-assembled layer of the organic compound according to Example 2.

FIG. 4 contains a schematic illustration of the five-stage ring oscillator from Example 9, a snapshot of the vibration on the oscilloscope and the dependence of the stage delay on the supply voltage.

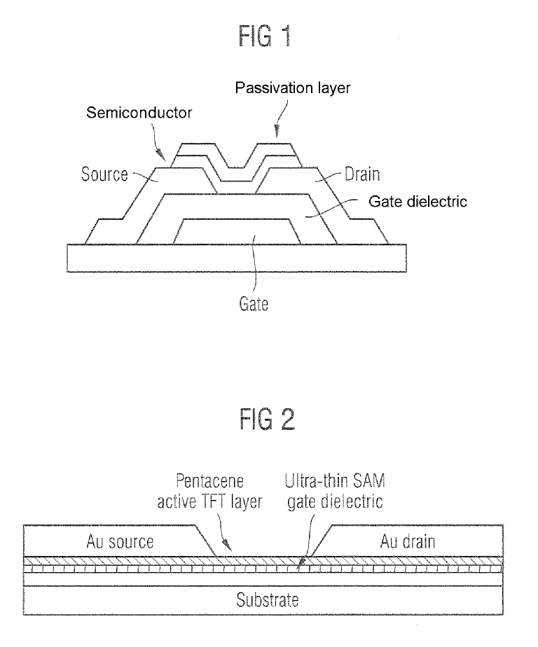

### DETAILED DESCRIPTION

In the following Detailed Description, reference is made to the accompanying drawings, which form a part hereof, and in which is shown by way of illustration specific embodiments in which the invention may be practiced. In this regard, directional terminology, such as “top,” “bottom,” “front,” “back,” “leading,” “trailing,” etc., is used with reference to the orientation of the Figure(s) being described. Because components of embodiments of the present invention can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims.

One or more embodiments provide synthesis processes which enable the preparation of organic compounds which form self-assembled monolayers (SAMs) on a metallic substrate, such as the gate electrode of a field-effect transistor, especially of an OFET, and which have a phosphonic acid group or a thiol group or a derivative thereof as an anchor group, and which are provided, in the ω-position to this anchor group, with a head group which is capable of π,π interaction and hence of top-linking. One or more embodiments provide simple synthesis processes with which these phosphonic acids, phosphonic acid derivatives, thiols and thiol derivatives can be obtained in high yields and which enable the problem-free removal of the desired products from the reaction mixture.

These organic materials are essential for the production of integrated circuits with low supply voltages based on organic transistors.

The applicants have made the surprising finding that long-chain phosphonic acids and thiols and derivatives thereof which have, in the ω-position to the thiol or phosphonic acid anchor group, a head group capable of top-linking can be prepared in high yield in a simple manner when a long-chain 1-alkene compound which has such a head group in the ω-position to the allyl group is used as a starting material of the synthesis. This finding forms the basis of the present invention.

Accordingly, the object of the invention is achieved by reacting

a compound of the general formula I

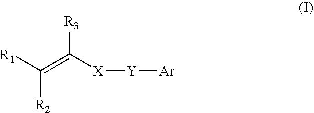

with a compound of the general formula II

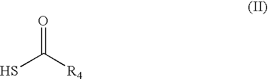

or a compound of the general formula III

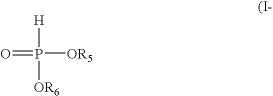

where the X, Y, Ar and R₁ to R₆ radicals are each:
X is a radical which is selected from
a) the alkyl chains which have from 2 to 20 carbon atoms and may be straight-chain or branched and/or substituted and/or may contain one or more unsaturated bonds;
b) the oligoether or oligothio chains of the general formula

—(CH₂—CH₂-A)ₙ-
in which A is oxygen or sulfur and
n=1-10;
Y is oxygen, sulfur, selenium or NH when X is a partly or fully fluorinated alkyl chain, and is (CH₂)ₘO, (CH₂)ₘSe or (CH₂)ₘNH when X is an oligoether or oligothioether chain, where m=1-20;
Ar is an optionally substituted aromatic group;
and
the R₁ to R₄ radicals are each independently hydrogen, alkyl radicals which have 1 to 20 carbon atoms and may be straight-chain or branched and/or substituted and/or contain an unsaturated bond, or a perfluoroalkyl radical;
R₅ and R₆ are each an alkyl radical which has from 1 to 20 carbon atoms and may be straight-chain or branched and/or mono- or polyunsaturated and/or may contain one or more unsaturated bonds, or a perfluoroalkyl radical.

In one embodiment, the X radical is an n-alkyl radical of the formula —(CH₂)ₙ— in which x is an integer in the range from 1 to 19.

Particular preference is given to organic compounds in which R₁, R₂ and R₃ are each hydrogen atoms.

In another embodiment, Ar is the following radicals:

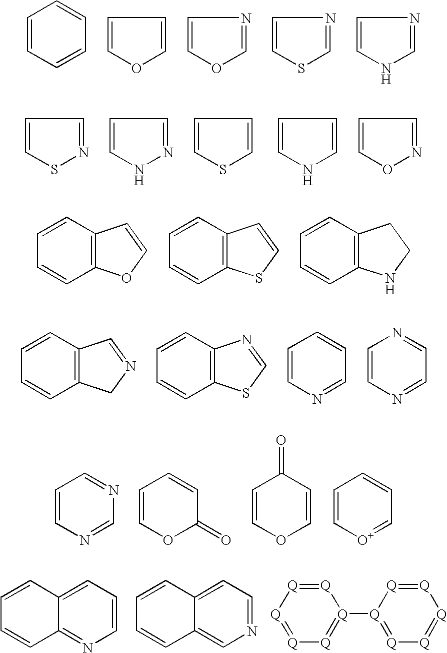

where Q is CH or N,

phenyl, naphthalene, anthracene, naphthacene, pentacene, biphenyl, terphenyl, quaterphenyl and/or quinquephenyl.

A particularly preferred Ar radical is the phenyl group.

The synthesis of the compounds of the general formula I is described in DE 103 28 890, whose contents are incorporated by reference into this application.

It has been found that, completely surprisingly, the compound of the general formula I can be reacted virtually quantitatively with a thiocarboxylic acid of the general formula II to obtain a thioester without adding a catalyst. The thioester can then be reduced with a reducing agent, very particularly with lithium aluminum hydride LiAlH₄, to the corresponding thiol. The resulting thiol binds to metallic components and surfaces, especially composed of noble metal, such as Au, Ag, Pt, Pd, Rh, Ru, etc., but also to some semiconductors such as GaAs or indium phosphide, and forms an SAM which is additionally stabilized by the head group.

This synthesis route employing the compounds of general formulas I and II is illustrated schematically below:

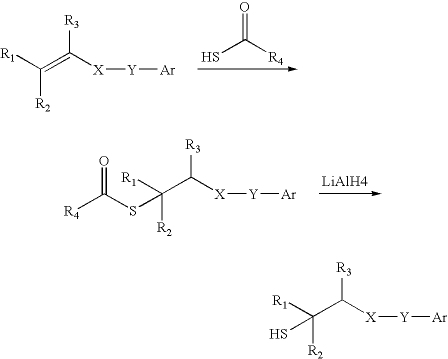

The reduction of the thioester is in some cases unnecessary. Many thioesters, such as the thioacetic ester, add to the surface composed of a noble metal, especially of gold, with elimination of the corresponding carboxylic acid, such as acetic acid, and then form a self-assembled monolayer.

When the compound of the general formula I

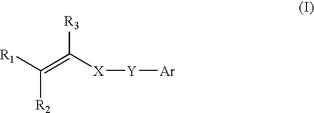

is reacted with a dialkyl phosphite of the general formula III

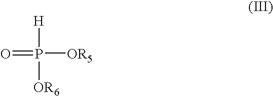

in the presence of AIBN (azobisisobutyronitrile), equally surprisingly, a phosphonic ester is formed in a free-radical reaction initiated by AIBN, and can be converted to the corresponding phosphonic acid via hydrolysis, for example with HCl/H₂O.

The process for preparing these phosphonic acids from a 1-alkene compound which already contains a head group is illustrated below:

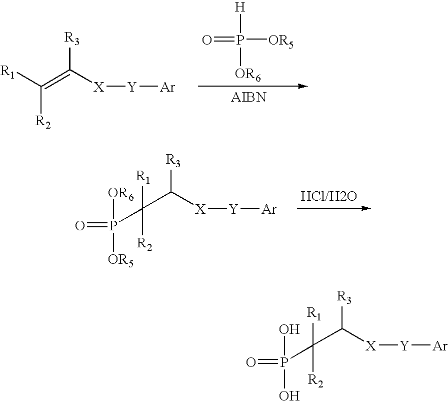

The above-described synthesis routes for the preparation of thiols and phosphonic acids and derivatives thereof are very flexible and enable the preparation of a large class of compounds which contain an anchor group (thiol radical or phosphonic acid radical) which can enter into an interaction with the surface, and a group in the co-position (the head group). These compounds form self-assembled monolayers on a surface via their anchor group, which are stabilized by the head groups.

The compounds with a phosphonic acid radical prepared by the process according to the invention bind particularly efficiently to layers of a material which is selected from aluminum, silicon and titanium. Owing to their base character, these materials are always coated with a thin oxide layer in an oxygenous atmosphere. Also within the scope of the invention are alloys which contain the metals mentioned in a proportion of greater than 30 weight. Aluminum or aluminum alloys are especially preferred.

The compounds which have a thiol radical and are prepared by the process according to the invention bind particularly efficiently to noble metal surfaces, for example electrodes which consist of silver, gold, platinum, rhodium, ruthenium, palladium or mercury or an alloy of one or more of these noble metals. Also within the scope of the invention are alloys which contain the metals mentioned in a proportion of greater than 30 weight. Especially preferred are surfaces which consist of gold or include gold.

The invention will be illustrated below with reference to working examples, which relate to the production of
organic materials which can be used in order to obtain gate dielectrics in the form of self-assembled monolayers (Examples 1 to 6);
organic field-effect transistors whose gate electrode with a bottom-gate structure consists of aluminum or gold and whose gate dielectric is formed from the organic materials according to Ex. 2 (for Al) or Ex. 5 (for Au) (Examples 7, 10 and 11);
components for the food packaging industry (Examples 8 and 12);
ring oscillators (Examples 9 and 13).

### EXAMPLE 1

### Synthesis of dimethyl 18-phenoxyoctadecyl-1-phosphonate

1.45 mmol (500 mg) of 18-phenoxy-1-octadecene are admixed under a protective gas atmosphere with 14.5 mmol (1.60 g; 1.33 ml) of dimethyl phosphite which have been freed of hydrolysis and oxidation products by preceding distillation. In a protective gas countercurrent, 20 mg of azobisisobutyronitrile are added, then the mixture is heated to 110° C. for 4 h. After cooling, a further 20 mg of azobisisobutyronitrile are added and the mixture is heated again to 120° C. for 4 h, followed by the addition of a further 20 mg of azobisisobutyronitrile after cooling and heating to 135° C. for 4 h.

The cooled crude product crystallizes out of the reaction mixture.

Excess dimethyl phosphite is removed first on a rotary evaporator at 20 mbar and 90° C. and then in an oil-pump vacuum at 135° C. Subsequently, the resulting product is analyzed by mass spectrometry and by nuclear resonance spectroscopy. The following results are obtained:

a) High-Resolution Mass Spectrometry (HRMS):

| | |
|---|---|
| calculated for ¹²C₂₆¹H₄₇¹⁶O₄³¹P: | 454.3212 g/mol |
| found (+El): | 454.3212 g/mol |

b) ¹H NMR spectroscopy (CDCl₃):

δ: 1.25-1.66 (m, 32H, H4-16), 1.35 (dtt, 2H, H3: ⁴J₃, ³¹P=3.38 Hz, ³J_{3.2}=6.87 Hz, ³J_{3.4}=7.26 Hz), 1.59 (dtt, 2H, H2; ³J₂=³¹P=13.95 Hz, ³J_{2.1}=7.13 Hz, ³J_{2.3}=6.87 Hz), 1.69-1.80 m (m, 4H, H1+H17), 3.74 (d, 6H, CH₃; ³J_{HMe}, ³¹P=10.74 Hz), 3.95 (t, 2H, H18; ³J_{18.17}=6.56 Hz), 6.88-6.95 (m, 3H, H_{Ph}), 7.27 (m, 2H, H_{Ph})

c) ¹³C NMR Spectroscopy (CDCl₃):

δ: 22.30 (d, C2; ²J_{C2}, ³¹P=5.16 Hz), 24.69 (d, C1; ¹J_{C1}, ³¹P=140.24 Hz), 26.09 (C17), (29.10, 29.33, 29.38, 29.43, 29.60, 29.64, 29.69) (C4-16), 30.60 (d, C3; ³J_{C3}, ³¹P=16.83 Hz), 52.27 (d, C_{Me}, ³¹P=6.64 Hz), 67.91 (C18), 114.54 (C₀), 120.45 (C_{P}), 129.38 (Cₘ), 159.18 (C_{Ar})

The spectroscopic analyses according to a), b) and c) illustrate that, in the case of use of the process according to the invention, the desired dimethyl phosphonate is formed.

### EXAMPLE 2

### Synthesis of 18-phenoxyoctadecylphosphonic acid

0.30 mmol (136 mg) of the dimethyl 18-phenoxyoctadecylphosphonate prepared in Example 1 is admixed as a solid with 6 ml of 2 molar aqueous hydrochloric acid, and the reaction mixture is heated to boiling for 1 h. After cooling, the crude product crystallizes out, is filtered off with suction and is washed with water.

### EXAMPLE 3

### Synthesis of diethyl 18-phenoxyoctadecylphosphonate

The reaction is performed as in Example 1 with the difference that diethyl phosphite is used instead of dimethyl phosphite. This affords the corresponding diethyl ester. Subsequently, the diethyl ester is hydrolyzed under the reaction conditions specified in Example 2 to give 18-phenoxyoctadecylphosphonic acid.

### EXAMPLE 4

### Synthesis of S-(18-phenoxyoctadecyl) 1-thioacetate

0.435 mmol (150 mg) of 18-phenoxy-1-octadecene (compound of the formula I) are dissolved under a protective gas atmosphere in 42.0 mmol (3.20 g; 3.00 ml) of thioacetic acid, stirred at room temperature for 24 h, then heated to 65° C. for 1 h and subsequently stirred at room temperature for another 48 h. The excess thioacetic acid is then removed rapidly on a rotary evaporator. The crude product is chromatographed with methylene chloride/petroleum ether (boiling range 35-60° C.) on a silica gel column. After removal of the solvent, the thioacetate is obtained in the form of colorless crystals.

a) Elemental Analysis

S-(18-Phenoxyoctadecyl) 1-thioacetate (C₂₆H₄₄O₂S) has a molar mass of 420.70 g/mol. In the table which follows, the calculated percentage of the different elements and that actually found in the elemental analysis are reported:

TABLE

| | C (%) | H (%) | S (%) | O (%) |
|---|---|---|---|---|
| calculated | 74.23 | 10.54 | 7.62 | 7.61 |
| found | 74.09 | 10.56 | 7.87 | 7.48 |

b) High-Resolution Mass Spectrometry (HRMS):

| | |
|---|---|
| calculated for ¹²C₂₆¹H₄₄¹⁶O₂³²S: | 420.3062 g/mol |
| found (+El): | 420.3063 g/mol |

c) ¹H NMR Spectroscopy (CDCl₃):

δ: 1.25-1.42 (m, 28H, H3-16), 1.53 (dtt, 2H, H2; ³J_{2.1}=7.30 Hz, ³J_{2.3}=7.40 Hz); 1.78 (tt, 2H, H17; ³J_{17.18}=6.60 Hz, ³J_{17.16}=7.30 Hz), 2.32 (s, 3H, CH₃), 2.86 (t, 2H, H1; ³J_{1.2}=7.30 Hz), 3.95 (t, 2H, H18; ³J_{18.17}=6.60 Hz), 6.88-6.95 (m, 3H, H_{Ph}), 7.27 (m, 2H, H_{Ph})

d ¹³C NMR Spectroscopy (CDCl₃):

δ: (26.07-29.69) (C3-17), 30.66 (CH₃), 67.88 (C18), 114.08 (C1), 114.49 (Cₒ), 120.43 (Cₚ), 129.39 (Cₘ), 159.13 (C_{Ar}), 196.08 (C═O)

The analyses according to a), b), c) and d) illustrate that, in the case of use of the process according to the invention, the desired thioacetate is formed.

### EXAMPLE 5

### Synthesis of 18-phenoxyoctadecanethiol

0.238 mmol (100 mg) of S-(18-phenoxyoctadecyl) 1-thioacetate is dissolved under a protective gas atmosphere in a mixture of 4.0 ml of diethyl ether and 4.0 ml of tetrahydrofuran. 0.949 mmol (25 mg) of lithium aluminum hydride is added as a solid in a countercurrent, after which the mixture is stirred at room temperature for 30 min. The mixture is then cautiously diluted with 20 ml of diethyl ether and hydrolyzed by adding 15 ml of water which has been degassed beforehand by passing a nitrogen stream through it. Likewise degassed 10% hydrochloric acid is then added dropwise until all salts have dissolved. The organic phase is removed, and dried over anhydrous sodium sulfate. The solvents are removed on a rotary evaporator, and the crude product is chromatographed with methylene chloride/petroleum ether on a silica gel column.

a) High-Resolution Mass Spectrometry (HRMS):

| | |
|---|---|
| calculated for ¹²H₂₂¹H₄₂¹⁶O₄³²S: | 378.2956 g/mol |
| found (+El): | 378.2961 g/mol |

b) ¹H NMR Spectroscopy (CDCl₃):

δ: 1.25-1.67 (m, 31H, H2-16+SH), 1.76 (tt, 2H, H17; ³J_{17.18}=6.60 Hz, ³J_{17.16}=7.49 Hz), 2.51 (m, 2H, H1), 3.95 (t, 2H, H18; ³J_{18.17}=6.57 Hz), 6.86-6.94 (m, 3H, H_{Ph}), 7.28 (m, 2H, H_{Ph})

c) ¹³C NMR Spectroscopy (CDCl₃):

δ: 24.64 (C1), (24.68-29.73) (C₃-16), 26.09 (C17), 34.14 (C2), 67.90 (C18), 114.54 (Cₒ), 120.44 (Cₚ), 129.37 (Cₘ), 159.17 (C_{Ar})

### EXAMPLE 6

### Synthesis of S-(18-phenoxyoctadecyl) 1-thio-propionate

The reaction is performed as in Example 4 with the difference that thiopropionic acid is used instead of thioacetic acid. This affords the corresponding thiopropionate. Subsequently, the thiopropionate is hydrolyzed under the reaction conditions specified in Example 5 to give 18-phenoxyoctadecanethiol.

### EXAMPLE 7

### Production of an Organic Field-Effect Transistor with a Gate Electrode Composed of Aluminum

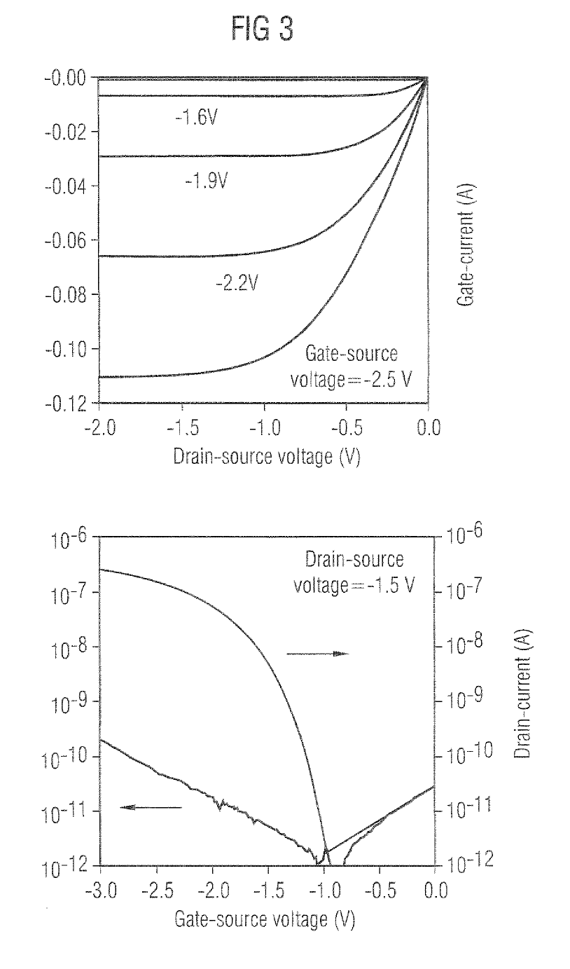

Aluminum is applied by vapor deposition to a glass plate with a layer thickness of 100 nm under vacuum. To obtain the gate dielectric from the organic compound obtained in Example 2, the self-assembled monolayer is deposited from the liquid phase or the gas phase or in μ contact printing as described in DE 10 2004 00 960.7. Subsequently, 30 nm of pentacene are applied by vapor deposition from the gas phase. The transistor test structure illustrated in FIG. 2 is completed by application of gold electrodes by vapor deposition through a shadow mask. The transistor characteristics obtained for this transistor are illustrated in FIG. 3.

### EXAMPLE 8

### Production of a Component for the Food Packaging Industry

The production process described in Example 7 is performed with the difference that a polyester film as used, for example, in the food packaging industry, instead of a glass plate, is subjected to vapor deposition with aluminum. The finished component can be used in the food packaging industry for the labeling of foods.

### EXAMPLE 9

### Production of a Ring Oscillator

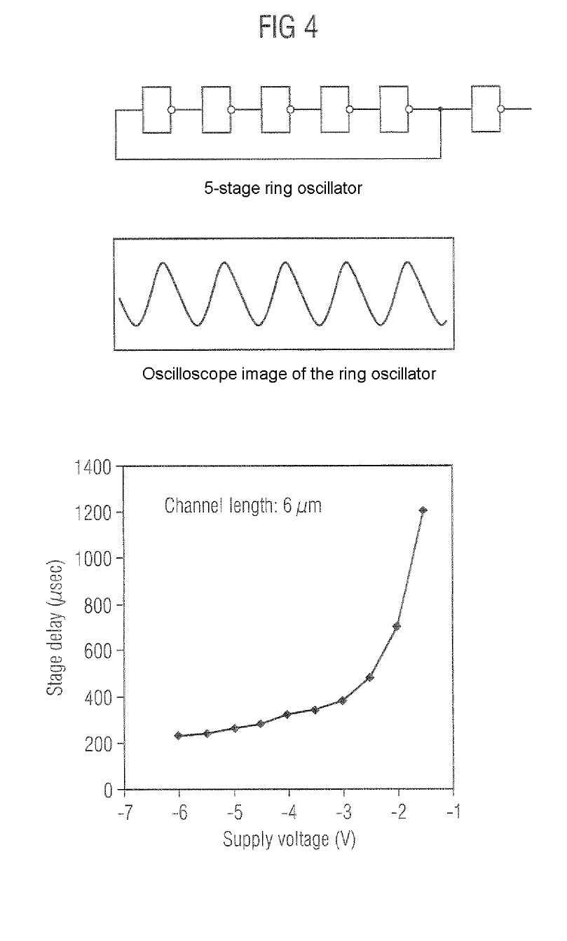

After the vapor deposition with aluminum, the glass plate from Example 7 is provided with a photoresist and illuminated with a wavelength of 365 nm through a chromium-on-glass mask. The photoresist is developed with an aqueous KOH solution, which simultaneously also etches the aluminum layer. After the stripping of the photoresist with acetone and ultrasound, a bottom-contact transistor structure according to FIG. 2 is completed in the further structuring analogously to Example 7. The individual masks were adjusted relative to one another and the transistors were connected to one another so as to form a ring oscillator according to FIG. 4. An oscilloscope image of the ring oscillator and the dependence of the stage delay on the supply voltage of the ring oscillator are likewise depicted in FIG. 4.

### EXAMPLE 10

### Production of an Organic Field-Effect Transistor with a Gate Electrode Composed of Gold

100 nm of gold are applied by vapor deposition to a glass plate under vacuum. To obtain a gate dielectric from the organic compound obtained in Example 5, the self-assembled monolayer is deposited from the liquid phase or the gas phase or in μ contact printing as described above in Example 7. Subsequently, 30 nm of pentacene are applied by vapor deposition from the gas phase. The transistor test structure illustrated in FIG. 2 is completed by vapor deposition of gold electrodes through a shadow mask.

### EXAMPLE 11

### Production of an Organic Field-Effect Transistor with a Gate Electrode Composed of Platinum or Palladium

The OFETs are produced as in Example 10 with the difference that platinum or palladium is applied to the glass plate by vapor deposition in the first process to obtain the gate electrode. In the next step, as in Example 10, very stable SAMs with top-link are obtained when the organic compound obtained in Example 5 is used.

### EXAMPLE 12

### Production of a Component for the Food Packaging Industry

The production process described in Example 10 is performed with the difference that a polyester film as used, for example, in the food packaging industry, instead of a glass plate, is subjected to vapor deposition with a very thin gold layer. The resulting substrate is suitable for the production of polymer-electronic circuits, such as those of an organic field-effect transistor for the labeling of foods in the food packaging industry.

### EXAMPLE 13

### Production of a Ring Oscillator

After the vapor deposition with gold, the glass plate from Example 10 is provided with a photoresist and illuminated with a wavelength of 365 nm through a chromium-on-glass mask. The photoresist is developed with an aqueous KOH solution. The gold layer is etched in highly diluted aqua regia (1:30). After stripping of the photoresist with acetone and ultrasound, a bottom-contact transistor structure according to FIG. 2 is completed in the further structuring analogously to Example 10. The individual masks were adjusted relative to one another and the transistors were connected to one another so as to form a ring oscillator which corresponds to the ring oscillator depicted in FIG. 4.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

What is claimed is:

1.-14. (canceled)

15. A process for preparing an organic compound capable of forming a self-assembled monolayer, the process comprising reacting a compound of the general formula I with 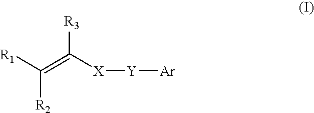
either a compound of the general formula II
or a 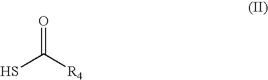
compound of the general formula III
where 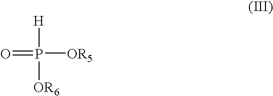
X is:
where A is oxygen or su
where Y is:
oxygen, sulfur, selenium or NH, or
(CH₂)ₘO, (CH₂)ₘS or (CH₂)ₘNH when X is an oligoether or oligothioether chain, where m is an integer ranging from 1 to 20;
where Ar is an aromatic group;
where R₁, R₂, R₃, and R₄ are each independently (i) hydrogen, (ii) an alkyl radical having 1 to 20 carbon atoms, or (iii) a perfluoroalkyl radical; and
where R₅ and R₆ are each independently (i) an alkyl radical having 1 to 20 carbon atoms, or (ii) a perfluoroalkyl radical.

16. The process of claim 15 wherein X is a straight alkyl chain.

17. The process of claim 15 wherein X is a branched alkyl chain.

18. The process of claim 15 wherein X is an alkyl chain and the alkyl chain is substituted.

19. The process of claim 15 wherein X is an alkyl chain and the alkyl chain includes one or more unsaturated bonds;

20. The process of claim 15 wherein X is an n-alkyl chain of formula —(CH₂)_{z}— where z is an integer ranging from 1 to 19.

21. The process of claim 15 wherein X is a partly or fully fluorinated alkyl chain

22. The process of claim 15 wherein R₁, R₂ and R₃ are each hydrogen.

23. The process of claim 15 wherein an alkyl chain at R₁, R₂, R₃, R₄, R₅, R₆, or any combination of these is a straight alkyl chain.

24. The process of claim 15 wherein an alkyl chain at R₁, R₂, R₃, R₄, R₅, R₆, or any combination of these is a branched alkyl chain.

25. The process of claim 15 wherein an alkyl chain at R₁, R₂, R₃, R₄, R₅, R₆, or any combination of these is substituted.

26. The process of claim 15 wherein an alkyl chain at R₁, R₂, R₃, R₄, R₅, R₆, or any combination of these includes one or more unsaturated bonds.

27. The process of claim 15 wherein the aromatic group at Ar is substituted at least one substitutable position.

28. The process of claim 15 wherein the aromatic group at Ar is free of any substitution.

29. The process of claim 15 wherein Ar is phenyl.

30. The process of claim 15 wherein Ar is phenyl, naphthalene, anthracene, naphthacene, pentacene, biphenyl, terphenyl, quaterphenyl, quinquephenyl, 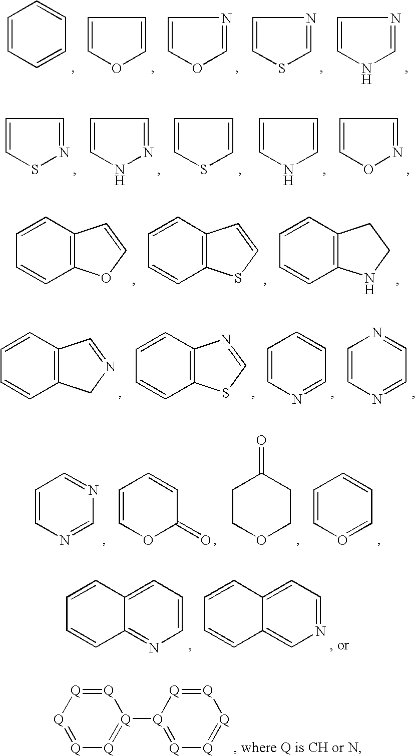
or any of these substituted with an alkyl radical.

31. The process of claim 15, the process further comprising performing the reaction of the compound of the general formula I with the compound of the general formula III in the presence of azobisisobutyronitrile.

32. The process of claim 15, the process further comprising performing the reaction of the compound of the general formula I with the compound of the general formula II in the absence of catalyst.

33. The process of claim 15 wherein reacting the compound of the general formula I with the compound of the general formula II yields a thioester that, upon reduction, becomes a compound of general formula IIa:

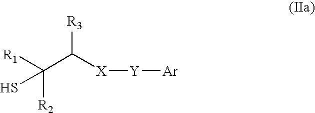

34. The process of claim 33, the process further comprising reducing the compound formed by reacting the compound of the general formula I with the compound of the general formula II to obtain the compound of the general formula IIa.

35. The process of claim 34 wherein the reduction is performed using LiAlH₄.

36. The process of claim 15 wherein reacting the compound of the general formula I with the compound of the general formula III yields a phosphonic ester that, upon hydrolysis, becomes a compound of general formula IIb:

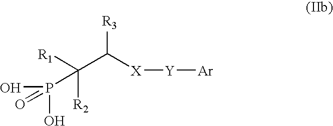

37. The process of claim 36, the process further comprising Hydrolysing the compound formed by reacting the compound of the general formula I with the compound of the general formula III to obtain the compound of the general formula IIb.

38. A thiol derivative obtainable by the process of claim 15.

39. A phosphonic acid derivative obtainable by the process of claim 15.

40. A process for preparing semiconductor elements, wherein the process of claim 15 yields the organic compound or a precursor of the organic compound, the process for preparing semiconductor elements comprising applying the organic compound or the precursor of the organic compound to a substrate.

41. An organic compound capable of forming a self-assembled monolayer, the organic compound represented by general formula IIa: 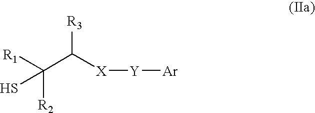
where X is:
a) an alkyl chain having 2 to 20 carbon atoms;
b) an oligoether or oligothio chain of the general formula —(CH₂—CH₂-A)ₙ-, where A is oxygen or sulfur and n is an integer raging from 2 to 10;
where Y is:
oxygen, sulfur, selenium or NH, or
(CH₂)ₘO, (CH₂)ₘS or (CH₂)ₘNH when X is an oligoether or oligothioether chain, where m is an integer ranging from 1 to 20;
where Ar is an aromatic group; and
where R₁, R₂, and R₃ are each independently (i) hydrogen, (ii) an alkyl radical having 1 to 20 carbon atoms, or (iii) a perfluoroalkyl radical.

42. An organic compound capable of forming a self-assembled monolayer, the organic compound represented by general formula IIb: 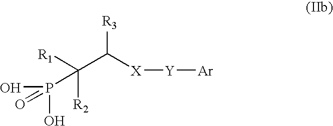
where X is:
a) an alkyl chain having 2 to 20 carbon atoms;
b) an oligoether or oligothio chain of the general formula —(CH₂—CH₂-A)ₙ-, where A is oxygen or sulfur and n is an integer raging from 2 to 10;
where Y is:
oxygen, sulfur, selenium or NH, or
(CH₂)ₘO, (CH₂)ₘS or (CH₂)ₘNH when X is an oligoether or oligothioether chain, where m is an integer ranging from 1 to 20;
where Ar is an aromatic group; and
where R₁, R₂, and R₃ are each independently (i) hydrogen, (ii) an alkyl radical having 1 to 20 carbon atoms, or (iii) a perfluoroalkyl radical.
